(19) United States
(12) Patent Application Publication
(10) Pub. No.: US 2007/0287821 A1
(43) Pub. Date: Dec. 13, 2007

(54) Synthesis of Polynaphthalenes and Their Use

(75) Inventors: Florian Doetz, Heidelberg (DE); Simon Nord, Romerberg (DE); Horst Weiss, Neuhofen (DE); Joachim Rosch, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/574,546

(22) PCT Filed: Sep. 5, 2005
(86) PCT No.: PCT/EP05/09525

§ 371 Date: Apr. 17, 2007

(30) Foreign Application Priority Data
Sep. 6, 2004 (DE) 10 2004 043 492.2

(51) Int. Cl. C08G 61/10; H01B 1/12

(52) U.S. Cl. 528/8; 528/396; 528/425; 528/86

(57) ABSTRACT

The present invention relates to a process for preparing polynaphthalene derivatives comprising repeating units of the general formula Ia and/or Ib 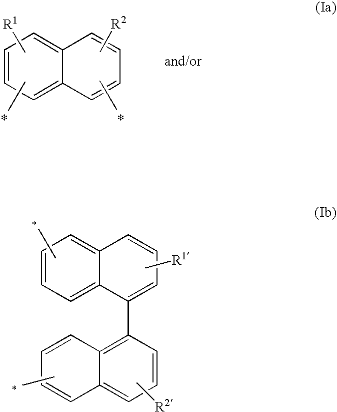
where R¹, R², R^{1′}, R^{2′} are as defined in the description. The present invention further relates to polynaphthalene derivatives which can be prepared by the process of the invention, films comprising or consisting of at least one polynaphthalene derivative according to the invention, organic light-emitting diodes (OLEDs) comprising at least one polynaphthalene derivative according to the invention, a light-emitting layer comprising or consisting of at least one polynaphthalene derivative according to the invention, an OLED comprising the light-emitting layer of the invention, devices comprising an OLED according to the invention and the use of the polynaphthalene derivatives of the invention as emitter substances in OLEDs.

The present invention relates to a process for preparing polynaphthalene derivatives, polynaphthalene derivatives which can be prepared by the process of the invention, films comprising or consisting of at least one polynaphthalene derivative according to the invention, organic light-emitting diodes (OLEDs) comprising at least one polynaphthalene derivative according to the invention, a light-emitting layer comprising or consisting of at least one polynaphthalene derivative according to the invention, an OLED comprising the light-emitting layer of the invention, devices comprising an OLED according to the invention and the use of the polynaphthalene derivatives of the invention as emitter substances in OLEDs.

Organic light-emitting diodes (OLEDs) exploit the ability of particular materials to emit light when they are excited by an electric current. OLEDs are of particular interest as alternatives to cathode ray tubes and liquid crystal displays for producing flat VDUs.

Numerous materials which emit light on excitation by an electric current have been proposed.

An overview of OLEDs is given, for example, in M. T. Bernius et al., Adv. Mat. 2000, 12, 1737. The demands made of the compounds used are high and the known materials are usually not able to meet all the requirements.

Apart from inorganic and low molecular weight organic electroluminescence materials, the prior art also describes the use of polymeric electroluminescence materials in OLEDs which have a film of a conjugated polymer as light-emitting layer. In contrast to low molecular weight electroluminescence materials, polymeric materials can also be applied from solution, for example by spin coating or dipping, which makes it possible to produce large-area displays simply and inexpensively.

WO 90/13148 relates to OLEDs comprising polymers based on poly(p-phenylene-vinylene) (PPV). Such polymers are particularly suitable for electroluminescence in the red and green regions of the spectrum.

In the blue region of the spectrum, use is usually made of derivatives of poly(fluorene) (PF). Poly(fluorene) derivates having spiro centers are disclosed, for example, in EP-A 0 707 020.

Although the abovementioned PPV and PF derivatives usually have satisfactory optical properties such as emission color and quantum yield of the emission, they generally lack the necessary long-term stability. The reasons for this extend from morphological instability via excimer formation to oxidative degradation of the chromophore.

DE-A 40 24 647 relates to aromatic condensation products which can be 1,4-linked naphthalene units. These condensation products are prepared either by means of a Grignard reaction of naphthyl bromides with brominated naphthalene derivatives or by reaction of naphthalene borates with brominated naphthalene derivatives. The aromatic condensation products are suitable as materials for thermal insulation and as electrode materials. The use in OLEDs is not mentioned.

Martin et al., J. Org. Chem. 2000, 65, 7501 to 7511 relates to vinylene copolymers comprising naphthalene units which can be prepared by the Knoevenagel reaction. Chiral block copolymers made up of conjugated and unconjugated units and comprising binaphthyl units are disclosed. The fluorescence of these polymers is examined.

Müllen et al., Macromolecules 1993, 26, 1248 to 1253, relates to alkyl-substituted poly(naphthalenes) which are obtained by coupling of aryl bromides with aromatic boronic acids in the presence of transition metal catalysts. The poly(naphthalenes) disclosed bear solubility-improving C₆H₁₃- or C₁₂H₂₅-alkyl groups. The poly(naphthalenes) disclosed are linked via the 1 and 4 positions of the naphthalene units. The use of the poly(naphthalenes) in OLEDs is not mentioned.

In Smith, Jr. et al., Tetrahedron 58 (2002) 10197 to 10203 discloses bis-ortho-diynyl-arene compounds (BODA) which are prepared by palladium-catalyzed cross-coupling of tetraalkynylsilanes and aryl bromides and iodides. Polynapthalene networks can be obtained in this way, but their structure is not disclosed. The absorption and emission spectra of the polymers prepared were determined.

It is an object of the present invention to prepare further polynapthalene derivatives which are suitable for use in OLEDs, in particular as emitter molecules, have a long life, are highly efficient in OLEDs, have an emission maximum in the blue region and display a high quantum yield. A further object of the present invention is to provide a process for preparing such polynapthalenes.

This object is achieved by a process for preparing polynaphthalenes comprising repeating units of the general formula Ia and/or Ib 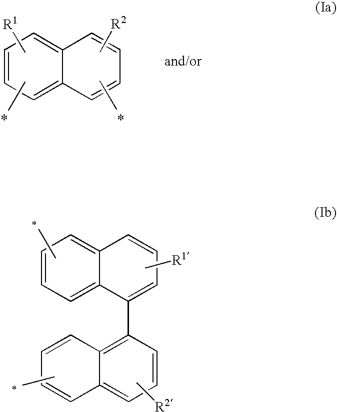
comprising
polymerisation of a monomeric naphthalene derivative of the formula IIa and/or IIb 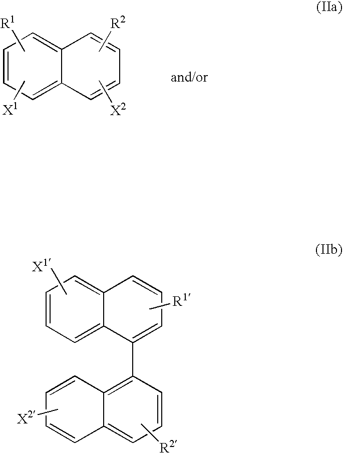
if appropriate together with at least one further comonomer selected from the group consisting of further naphthalene derivatives of the formula IIa and/or IIb which are different from the first naphthalene derivative of the formula IIa and/or IIb, aromatic, fused aromatic, heteroaromatic compounds, fluoranthene derivatives, benzene derivatives, anthrylene compounds, arylamino compounds, fluorene derivatives, carbazole derivatives, dibenzofuran derivatives, pyrene derivatives, phenanthrene derivatives, perylene derivatives, rubrene derivatives and thiophene compounds which each have two groups X³ and X⁴ which are capable of polymerization with the groups X¹ and X² of the naphthalene derivative of the formula IIa or with the groups X^{1′} and X^{2′} of the naphthalene derivative of the formula IIb,
where the symbols have the following meanings:
R¹, R² are each, independently of one another, H, an alkyl radical, an alkoxy radical, an aromatic radical, an aryloxy radical, a fused aromatic ring system, a heteroaromatic radical, an oligophenyl group;
R^{1′}, R^{2′} are each, independently, of one another, H, an alkyl radical, an alkoxy radical, an aromatic radical, an aryloxy radical, a fused aromatic ring system, a heteroaromatic radical;
X¹, X², X³,
X⁴, X^{1′}, X^{2′} are groups capable of polymerization with one another,
   or
R¹ or R²
   or
R^{1′} or R^{2′} are each, independently of one another, —CH═CH₂, —C≡CH, trans- or cis CH═CH—C₆H₅, acryloyl, methacryloyl, ortho-methylstyryl, para-methylstyryl, —O—CH═CH₂, glycidyl, 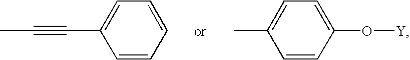
where Y is acryloyl, methacryloyl, ortho-methylstyryl, para-methylstyryl, —O—CH═CH₂, glycidyl or trans- or cis-CH═CH—C₆H₅.

For the purposes of the present application, “alkyl” is a linear, branched or cyclic substituted or unsubstituted C₁-C₂₀-, preferably C₁-C₉-alkyl group. Particular preference is given to a linear or branched C₃-C₉-, very particularly preferably C₅-C₉-alkyl group. The alkyl groups can be unsubstituted or be substituted by aromatic radicals, halogen, nitro, ether or carboxyl groups. The alkyl groups are particularly preferably unsubstituted. Furthermore, one or more nonadjacent carbon atoms of the alkyl group may be replaced by Si, P, O or S, preferably by O, or S. O or S are particularly preferably directly adjacent to the naphthalene system. Preferred halogen groups are F, Cl or Br.

For the purposes of the present application, “alkoxy” is a group of the formula —OR³, where the radical R³ is an alkyl group as defined above. Preferred alkyl radicals R³ have been mentioned above. The radical OR³ is thus particularly preferably —OC₃₋₉-alkyl, very particularly preferably —OC₅₋₉-alkyl, where the alkyl group is linear or branched and may be substituted as mentioned with regard to the alkyl groups.

For the purposes of the present invention, an “aromatic radical” is preferably a C₆-aryl group (phenyl group) or naphthyl group, particularly preferably a phenyl group. This aryl group can be unsubstituted or substituted by linear, branched or cyclic C₁- C₂₀, preferably C₁-C₉-alkyl groups which may in turn be substituted by halogen, nitro, ether or carboxyl groups. Furthermore, one or more carbon atoms of the alkyl group may be replaced by Si, P, O, S or N, preferably O or S. Furthermore, the aryl groups may be substituted by halogen, nitro, carboxyl groups, amino groups or alkoxy groups or C₆-C₁₄-, preferably C₆-C₁₀-aryl groups, in particular phenyl or naphthyl groups. Among halogen groups, preference is given to F, Cl, or Br. An “aromatic radical” is particularly preferably a C₆-aryl group which may be substituted by halogen, preferably Br, Cl or F, amino groups, preferably NAr′Ar″, where Ar′ and Ar″ are, independently of one another, C₆-aryl groups which may, as defined above, be unsubstituted or substituted. This aryl group is very particularly preferably unsubstituted.

For the purposes of the present application, “aryloxy” is a group of the formula —OR⁴, where the radical R⁴ is an aromatic radical as mentioned above. The radical is preferably —OR⁴, —Ophenyl or —Onaphthyl, particularly preferably —Ophenyl. The aryl group R⁴ may be substituted as mentioned above.

For the purposes of the present patent application, a “fused aromatic ring system” is a fused aromatic ring system generally having from 10 to 20 carbon atoms, preferably from 10 to 14 carbon atoms. These fused aromatic ring systems can be unsubstituted or be substituted by linear, branched or cyclic C₁-C₂₀-, preferably C₁-C₉-alkyl groups which may in turn be substituted by halogen, nitro, ether or carboxyl groups. Furthermore, one or more carbon atoms of the alkyl group may be replaced by Si, P, O, S or N, preferably O or S. Furthermore, the fused aromatic groups may be substituted by halogen, nitro, carboxyl groups, amino groups or alkoxy groups or C₆-C₁₄-, preferably C₆-C₁₀-aryl groups, in particular phenyl or naphthyl groups. A “fused aromatic ring system” is particularly preferably a fused aromatic ring system which may be substituted by halogen, preferably Br, Cl or F, amino groups, preferably NAr′Ar″, where Ar and Ar′ are, independently of one another, C₆-arly groups which may, as defined above, be unsubstituted or substituted. The fused aromatic ring system is very particularly preferably unsubstituted. Suitable fused aromatic ring systems are, for example, naphthalene, anthracene, pyrene, phenanthrene or perylene.

For the purposes of the present patent application, a “heteroaromatic radical” is a C₅-C₁₄-, preferably C₆-C₁₂-, particularly preferably C₆-C₁₀-heteroaryl group containing at least one N, P, S or O atom. This heteroaryl group can be unsubstituted or be substituted by linear, branched or cyclic C₁-C₂₀-, preferably C₅-C₉-alkyl groups which may in turn be substituted by halogen, nitro, ether or carboxy groups. Furthermore, one or more carbon atoms of the alkyl group may be replaced by Si, P, O, S or N, preferably O or S.

Furthermore, the heteroaryl groups may be substituted by halogen, nitro, carboxyl groups, amino groups or alkoxy groups or C₆-C₁₄-, preferably C₆-C₁₀-aryl groups. Among halogen groups, preference is given to F, Cl or Br. A “heteroaromatic radical” is particularly preferably a heteroaryl group which may be substituted by halogen, preferably Br, Cl or F, amino groups, preferably NArAr′, where Ar and Ar′ are, independently of one another, C₆-aryl groups which may, as defined above, be unsubstituted or substituted. The heteroaryl group is very particularly preferably unsubstituted.

For the purposes of the present application, an “oligophenyl group” is a group of the general formula III 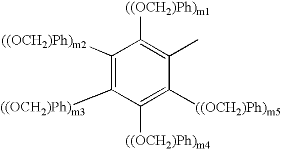
where Ph is in each case phenyl which may in turn be substituted by a group of the formula III in all 5 substitutable positions;
m¹, m², m³
m⁴ and m⁵ are each, independently of one another, 0 or 1, with at least one index m¹, m², m³, m⁴ or m⁵ being at least 1.

Oligophenyl groups in which m¹, m³ and m⁵ are 0 and m² and m⁴ are 1 or oligophenyl groups in which m¹, m², m⁴ and m⁵ are 0 and m³ is 1 are preferred.

The oligophenyl group can thus be a dendritic i.e. hyperbranched group, in particular when m¹, m³ and m⁵ are each 0 and m² and m⁴ are each 1 and the phenyl groups are in turn substituted by a group of the formula (III) in from 1 to 5 of their substitutable positions, preferably in two positions, particularly preferably, in the case of substitution in two positions, in each case in the meta position relative to the point of linkage to the base molecule of the formula (III).

However, the oligophenyl group can also be essentially unbranched, particularly when only one of the indices m¹, m², m³, m⁴ or m⁵ is 1; in the unbranched case, preference is given to m³ being 1 and m¹, m², m⁴ and m⁵ each being 0. The phenyl group can in turn be substituted by a group of the formula III in from 1 to 5 of its substitutable positions; the phenyl group is preferably substituted by a group of the formula III in one of its sub-substitutable positions, particularly preferably in the para position relative to the point of linkage to the base molecule. In the following, the substituents bound directly to the base molecule will be referred to as first substitution generations. The group of the formula III can in turn be substituted as defined above. In the following, the substituents bound to the first substituent generation will be referred to as second substituent generation.

Any number of further substituent generations analogous to the first and second substituent generations are possible. Preference is given to oligophenyl groups having the abovementioned substitution patterns which have a first substituent generation and a second substituent generation or oligophenyl groups which have only a first substituent generation.

The oligophenyl groups of the formula III are preferably bound benzylically via one of the phenyl radicals to the naphthalene skeleton of the monomeric naphthalene derivative of the formula IIa or IIb, for example:

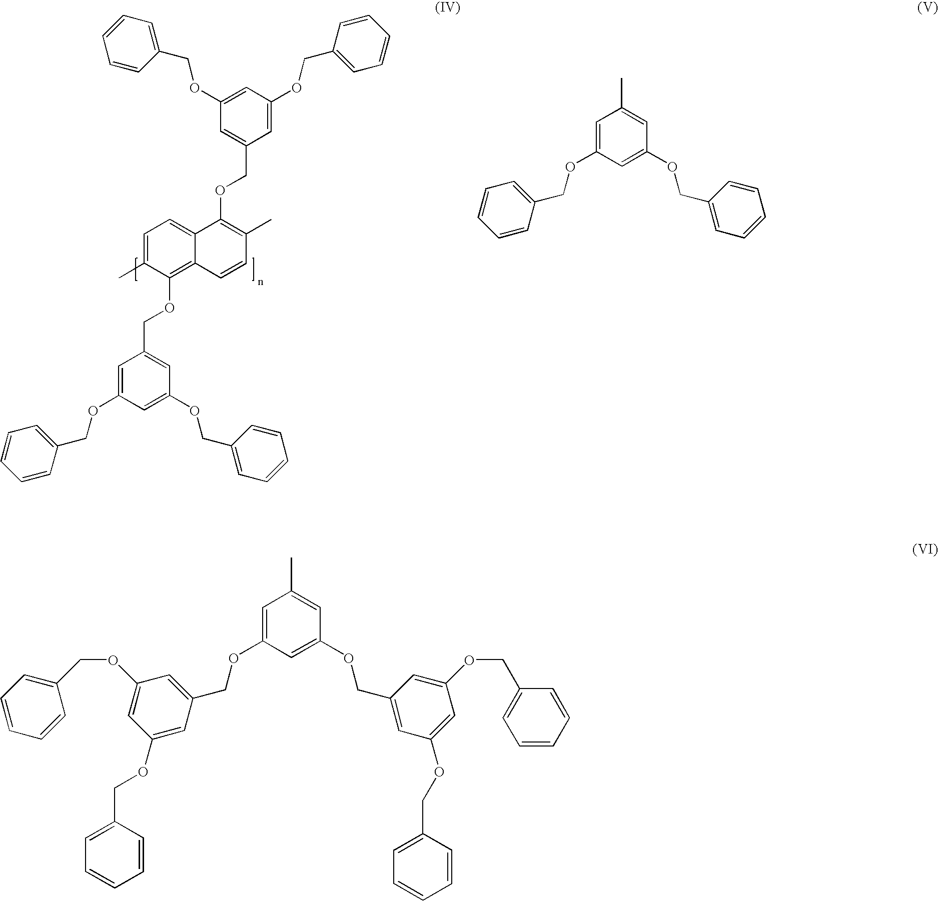

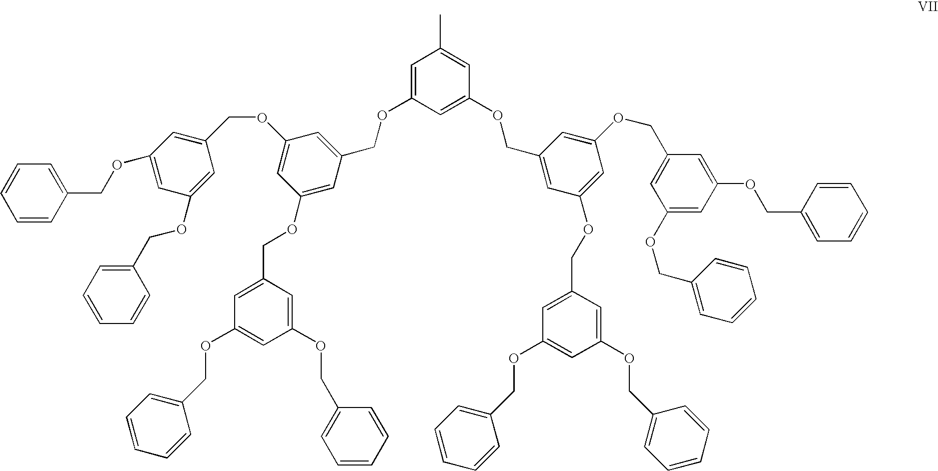

The radicals R¹ and R² in the compounds of the formulae Ia and IIa and the radicals R^{1′} and R^{2′} in the compounds of the formulae Ib and IIB are preferably alkyl radicals, particularly preferably C₃-C₁₀-alkyl radicals, very particularly preferably C₅-C₉-alkyl radicals, which may, in particular, be linear or branched, or alkoxy radicals, particularly preferably alkoxy radicals having a C₃-C₁₀-alkyl radical, very particularly preferably alkoxy radicals having a C₅-C₉-alkyl radical, with the alkyl radicals being linear or branched. Particular preference is given to R¹ and R² and/or R^{1′} and R^{2′} being alkoxy radicals.
X¹ and X²
   and/or
X^{1′} and X^{2′} are each preferably halogen selected from among F, Cl, Br and I, particularly preferably I or Br, esterified sulfonate or a boron-containing radical of the formula —B(O—[C(R⁷)₂]ₙ—O) or —B(OR^{7′})₂, where R⁷ and R^{7′} are identical or different and are each, independently of one another, H or C₁-C-₂₀-alkyl and n is an integer from 2 to 10, particular preference is given to X¹ and X² and/or X^{1′} and X^{2′} being boron-containing radicals of the formula —B(O—[C(R⁷)₂]ₙ—O) or —B(OR^{7′})₂, para-toluene sulfonate (tosylate), triflate (F₃—SO₃), para-nitrophenylsulfonate (nosylate), para-bromosulfonate (brosylate), very particularly preferably triflate, or boron-containing radicals of the formula —B(O—[C(R⁷)₂]ₙ—O) or —B(OR^{7′})₂, where
R⁷ and R^{7′} are identical or different and are each, independently of one another, hydrogen or C₁-C₂₀-alkyl, for example methyl, ethyl, n-propyl, iso-propyl, n-butyl, iso-butyl, sec.-butyl, tert-butyl, n-pentyl, iso-pentyl, sec.-pentyl, neo-pentyl, 1,2-dimethylpropyl, iso-amyl, n-hexyl, iso-hexyl sec.-hexyl, n-heptyl, iso-heptyl, n-octyl, n-decyl, n-dodecyl, or n-octadecyl; preferably C₁-C₁₂-alkyl such as methyl, ethyl, n-propyl, iso-propyl, n-butyl, iso-butyl, sec.-butyl, tert.-butyl, n-pentyl, iso-pentyl, sec.-pentyl, neo-pentyl, 1,2-dimethylpropyl, iso-aryl, n-hexyl, iso-hexyl, sec.-hexyl or n-decyl, particularly preferably C₁-C₄-alkyl such as methyl, ethyl, n-propyl, iso-propyl, n-butyl, iso-butyl, sec.-but or tert.-butyl, very particularly preferably methyl; and
n is an integer from 2 to 10, preferably from 2 to 5;
very particular preference is given to X¹ and X² being boron-containing radicals of the formula —B(O—[C(CH₃)₂]₂)—O) or —B(OH)₂;
X³ and X⁴ are each preferably halogen selected from among F, Cl, Br or I particularly preferably I or Br;
or
esterified sulfonate or a boron-containing radical of the formula —B(O—[C(R⁷)₂]ₙ—O) or —B(OR^{7′})₂, where R⁷ and R^{7′} are identical or different and each, independently of one another, H or C₁-C₂₀-alkyl and n is an integer from 2 to 10; particular preference is given to X³ and X⁴ being boron-containing radicals of the formula —B(O—[C(R⁷)₂]ₙ—O) or —B(OR^{7′})₂, para-toluene sulfonate (tosylate), triflate (F₃—SO₃), para-nitrophenylsulfonate (nosylate), para-bromosulfonate (brosylate), very particularly preferably triflate, or boron-containing radicals of the formula —B(O—[C(R⁷)₂]ₙ—O) or —B(OR^{7′})₂, where
R⁷ and R^{7′} are identical or different and are each, independently of one another, hydrogen or C₁-C₂₀-alkyl, for example methyl, ethyl, n-propyl, iso-propyl, n-butyl, iso-butyl, sec.-butyl, tert-butyl, n-pentyl, iso-pentyl, sec.-pentyl, neo-pentyl, 1,2-dimethylpropyl, iso-amyl, n-hexyl, iso-hexyl, sec.-hexyl, n-heptyl, iso-heptyl, n-octyl, n-decyl, n-dodecyl, or n-octadecyl; preferably C₁-C₁₂-alkyl such as methyl, ethyl, n-propyl, iso-propyl, n-butyl, iso-butyl, sec.-butyl, tert.-butyl, n-pentyl, iso-pentyl, sec.-pentyl, neo-pentyl, 1,2-dimethylpropyl, iso-amyl, n-hexyl, iso-hexyl, sec.-hexyl or n-decyl, particularly preferably C₁-C₄-alkyl such as methyl, ethyl, n-propyl, iso-propyl, n-butyl, iso-butyl, sec.-butyl or tert.-butyl, very particularly preferably methyl; and
n is an integer from 2 to 10, preferably from 2 to 5;
very particular preference is given to X³ and X⁴ being boron-containing radicals of the formula —B(O—[C(CH₃)₂]₂)—O) or —B(OH)₂;
   the radicals X¹ and X² and X^{1′} and X^{2′} and X³ and X⁴ are selected subject the following provisos:
   when X¹ and X² and/or X^{1′} and X^{2′} are in each case halogen, esterified sulfonate or a boron-containing radical, X³ and X⁴ are each likewise halogen, esterified sulfonate or a boron-containing radical, with the radicals X¹ and X² and/or X^{1′} and X^{2′} and also X³ and X⁴ being selected so that the molar ratio of halogen or esterified sulfonate to the boron-containing radical is from 0.8:2.1 to 2.1:0.8, preferably from 0.9:1.1 to 1.1:0.9, particularly preferably 1:1; or so that the radicals X¹ and X² and/or X^{1′} and X^{2′} in the monomeric naphthalene derivative of the formula IIa or IIb are each halogen and may be reacted with further comonomers whose radicals X³ and X⁴ are likewise halogen.

In a preferred embodiment of the present invention, the radical R¹ in the compound of the formula IIa is in the ortho position relative to the radical X¹ and/or the radical R² is in the ortho position relative to the radical X². It has been found that when the radicals R¹ and/or R² are in ortho positions relative to the radicals X¹ and/or X² in the monomeric naphthalene derivatives of the formula IIa, the dihedral angle between two adjacent repeating units (chromophores) in the polynaphthalene comprising repeating units of the general formula Ia, which is prepared by polymerization of monomeric naphthalene derivatives of the formula IIa, can be strongly influenced by choice of the bulkiness of the radicals R¹ and/or R². This results in a change in the overlap of the electrons of two adjacent chromophores and thus in the emission of the overall polymer chain. It has thus surprisingly been found that the emission color of the polymer can be controlled by selection of the radicals R¹ and/or R², which is not the case in such a pronounced way for other polymeric emitters.

Particularly preferred monomeric naphthalene derivatives of the formula IIa are thus monomeric naphthalene derivatives of the formulae IIa₁ and IIa₂ 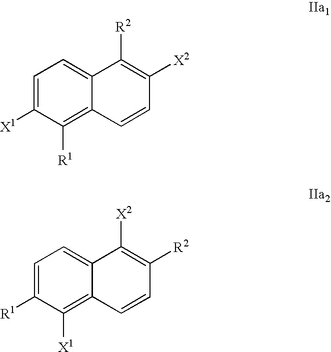
where the symbols X¹, X², R¹ and R² are as defined above.

In a further preferred embodiment, the present invention provides for the use of monomeric naphthalene derivatives of the formula in which the group X¹ is located in the 2 position of the naphthalene skeleton and the group X² is located in the 6 position of the naphthalene skeleton. The use of these monomeric naphthalene derivatives makes it possible to prepare 2,6-linked polynaphthalenes. Particular preference is given to the use of monomeric naphthalene derivatives of the formula IIa₁, in which X¹ is located in the 2 position of the naphthalene skeleton and X² is located in the 6 position of the naphthalene skeleton and R¹ is located in the ortho position relative to X¹ and R² is located in the ortho position relative to X².

Preferred naphthalene derivatives of the formula IIb are those of the formula IIb₁

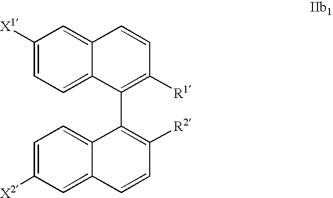

The monomeric naphthalene derivatives of the formula IIa are prepared by methods known to those skilled in the art. For example, two processes for preparing the preferred monomeric naphthalene derivatives of the formula IIa₁ and IIa₂ are described below:

1,5-dialkoxy-2,6-dibromonaphthalene can, for example, be prepared in two steps, as disclosed in Eur. J. Org. Chem. 1999, 643:

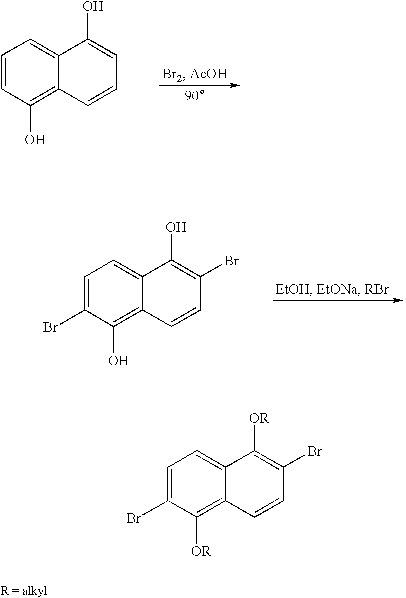

The bromo function can subsequently be converted by methods known to those skilled in the art into, for example, a boronic acid or an ester thereof.

1,5-dibromo-2,6-dialkylnaphthalene can be prepared in two steps as disclosed in Chem. Ber. 1992, 125, 2325:

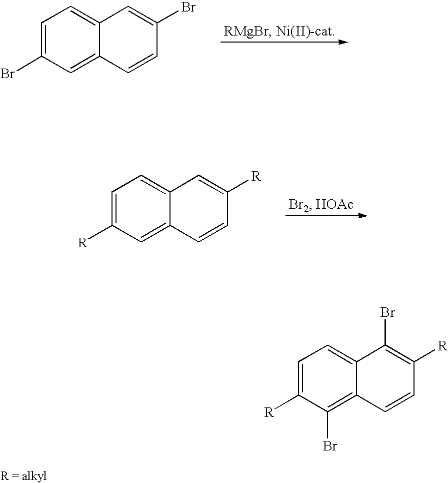

The monomeric naphthalene derivatives of the formula IIb are likewise prepared by methods known to those skilled in the art. For example, a process for preparing the preferred monomeric naphthalene derivative of the formula IIb₁ is shown below:

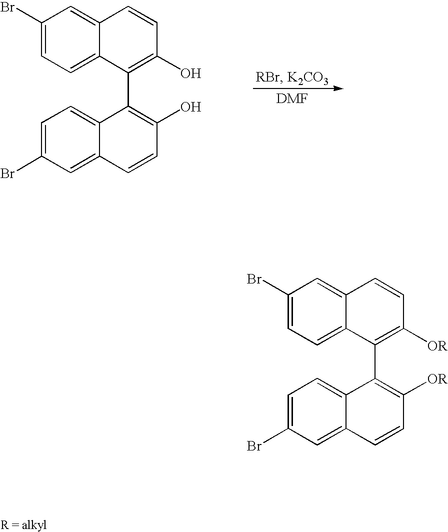

The alkylation of the free OH functions can be carried out by methods known to those skilled in the art.

Combinations of various substitution patterns in the monomeric naphthalene derivatives of the formulae IIa and IIb used enable both the emission color and supramolecular properties, for example the tendency to aggregate, of the desired polynaphthalenes comprising repeating units of the general formula Ia and Ib to be influenced.

The monomeric naphthalene derivatives of the formulae IIa and IIb are reacted, if appropriate together with at least one further comonomer selected from the group consisting of further naphthalene derivatives of the formula IIa and/or IIb which are different from the first naphthalene derivative of the formula IIa and/or IIb, aromatic, fused aromatic, heteroaromatic compounds, fluoranthene derivatives, benzene derivatives, anthrylene compounds, arylamine compounds, fluorene derivatives, carbazole derivatives, dibenzofuran derivatives, pyrene derivatives, phenanthrene derivatives, perylene derivatives, rubrene derivatives and thiophene derivatives which each have two groups X³ and X⁴ which are capable of polymerization with the groups X¹ and X² and/or X^{1′} and X^{2′} of the naphthalene derivatives of the formulae IIa and IIb.

The polymerization can in principle be carried out by means of any suitable polymerization process, depending on the polymerizable groups of the monomeric naphthalene derivatives X¹ and X² and/or X^{1′} and X^{2′} and the polymerizable groups of any further comonomers X³ and X⁴ used. Suitable polymerization processes and the polymerizable groups necessary for them are described, for example, in EP-A 1 245 659 (pages 26 to 31).

In a preferred embodiment, the polymerization of the naphthalene derivatives of the formula IIa and/or IIb, if appropriate together with at least one further comonomer, is carried out in the presence of nickel or palladium compounds, e.g. by means of Yamamoto coupling or the Suzuki reaction.

In this embodiment,
X¹, X², and/or
X^{1′} and X^{2′},
X³ and X⁴ are each halogen selected from among F, Cl, Br and I, esterified sulfonate or a boron-containing radical of the formula —B(O—[C(R⁷)₂]ₙ—O or a B(OR^{7′})₂ and
R⁷, R^{7′} are identical or different and each, independently of one another, H or C₁-C₂₀-alkyl;
n is an integer from 2 to 10;
   where the radicals X¹ and X² and/or X^{1′} and X^{2′} and also X³ and X⁴ are selected so that the molar ratio of halogen and esterified sulfonate to boron-containing radicals is from 0.8:2.1 to 2.1:0.8, preferably from 0.9:1.1 to 1.1:0.9, particularly preferably 1:1, or so that the radicals X¹ and X² and/or X^{1′} and X^{2′} in the monomeric naphthalene derivative are each halogen and these are reacted, if appropriate together with further comonomers in which the radicals X³ and X⁴ are likewise each halogen. That is to say, in a preferred embodiment, a reaction of monomeric naphthalene derivatives of the formula IIa and/or IIb is carried out, if appropriate with further comonomers, where all polymerizable groups X¹, X² and/or X^{1′} and X^{2′} and, if applicable, X³ and X⁴ are each halogen. In this case, the catalyst used is preferably a nickel compound. In a further preferred embodiment, a reaction of monomeric naphthalene derivatives of the formula IIa and/or IIb and, if appropriate, further comonomers, is carried out, with the polymerizable groups X¹, X² and/or X^{1′} and X^{2′} and, if applicable X³ and X⁴ being halogen or esterified sulfonate on the one side and boron-containing radicals on the other side in the above-described molar ratios. In this reaction, a halogen or esterified sulfonate is in each case reacted with a boron-containing radical. In this case, preference is given to using a palladium compound as catalyst.

Preferred meanings of X¹, X², X^{1′}, X^{2′}, X³, X⁴, R⁷, R^{7′} and n have been mentioned above.

In these embodiments of the process of the invention, the polymerization is preferably carried out in the presence of at least one nickel or palladium compound which is, in particular, in the oxidation state 0 or, in the case of palladium, in the presence of a mixture of Pd(II) salt and a ligand, for example Pd(ac)₂ and PPh3. Particular preference is given to using the commercially available tetrakis(triphenylphosphine)palladium [Pd(P(P₆H₅)₃)₄] and also commercially available nickel compounds, for example Ni(C₂H₄)₃, Ni(1,5-cyclooctadiene)₂ (“Ni(cod)₂”), Ni(1,6-cyclodecadiene)₂ or Ni(1,5,9-all-trans-cyclododecadiene)₂. Very particular preference is given to using [Pd(P(C₆H₅)₃)₄] and Ni(cod)₂. To carry out the polymerization, it is possible to add an excess of P(C₆H₅)₃ or 1,5-cyclooctadiene, depending on the catalyst used.

When the polymerization is carried out in the presence of palladium compounds, catalytic amounts, i.e. from 0.1 to 10 mol % of Pd, based on the monomeric naphthalene derivative of the formula IIa and/or IIb, if appropriate together with further comonomers, are usually sufficient. If the polymerization is carried out in the process of nickel compounds, stoichiometric amounts of Ni, based on the monomeric naphthalene derivative of the formula IIa and/or IIb, if appropriate together with further comonomers, are usually employed.

The polymerization is usually carried out in an organic solvent, for example in toluene, ethylbenzene, meta-xylene, ortho-Xylene, dimethylformamide (DMF), tetrahydrofuran, dioxane or mixtures of the abovementioned solvents. The solvent or solvents is/are freed of traces of moisture by customary methods prior to the polymerization.

The polymerization is usually carried out under protective gas. Suitable protective gases are nitrogen, CO₂ or noble gases, in particular argon or nitrogen.

The Suzuki reaction is usually carried out in the presence of a base, for example an organic amine. In particular the useful bases are triethylamine, pyridine and collidine.

The Suzuki reaction can also be carried out in the presence of solid basic salts, for example alkali metal carbonate or alkali metal bicarbonate, if appropriate in the presence of a crown ether such as 18-crown-6. It is likewise possible to carry out the Suzuki reaction as a two-phase reaction with aqueous solutions of alkali metal carbonate, if appropriate in the presence of a phase transfer catalyst. In this case, it is not necessary to free the organic solvents of moisture prior to the reaction.

The Suzuki reaction is particularly preferably carried out using alkali metal carbonates such as potassium or sodium carbonate.

The polymerization usually takes from 10 minutes to up to 3 days, preferably from 2 hours to up to 3 days. The pressure conditions are not critical, and atmospheric pressure is preferred. In general, the polymerization is carried out at elevated temperature, preferably in the range from 80° C. to the boiling point of the organic solvent or solvent mixture.

The molar ratio of the sum of halogen and esterified sulfonate to boron-containing radicals in the monomeric naphthalene derivatives of the formula IIa and/or IIb used and/or the further comonomers used is from 0.8:2.1 to 2.1:0.8, preferably from 0.9:1.1 to 1.1:0.9, particularly preferably 1:1.

The further comonomers selected from among aromatic, fused aromatic, heteroaromatic compounds, fluoranthene derivatives, benzene derivatives, anthrylene compounds, arylamino compounds, fluorene derivatives, carbazole derivatives, dibenzolfuran derivatives, pyrene derivatives, phenanthrene derivatives, perylene derivatives, rubrene derivatives and thiophene compounds may, if appropriate bear solubilizing alkyl or alkoxy side chains, for example 1 or 2 C₅-C₁₂alkyl- and/or C₅-C₁₂-alkoxy side chains, in addition to the polymerizable groups X³ and X⁴.

Particularly preferred further comonomers which are selected from the group consisting of aromatic, fused aromatic, heteroaromatic compounds, fluoranthene derivatives, benzene derivatives, anthrylene compounds, arylamino compounds, fluorene derivatives, carbazole derivatives, dibenzolfuran derivatives, pyrene derivatives, phenanthrene derivatives, perylene derivatives, rubrene derivatives and thiophene compounds which each bear two groups X³ and X⁴ capable of polymerization with the groups X¹ and X² and/or X^{1′} and X^{2′}, of the naphthalene derivative of the formula IIa and/or IIb and are suitable for use in the above-described preferred embodiment of the polymerization step of the process of the invention are:
phenylenebisboronic acids and esters thereof, preferably 1,4-phenylenebisboronic acid or esters thereof, and their alkyl or alkoxy-substituted derivatives,
dihalo-substituted benzenes, preferably 1,4-dihalo-substituted benzenes, and their alkyl- or alkoxy-substituted derivatives,
anthracenebisboronic acids or esters thereof, preferably 1,5- or 9,10-anthracenebisboronic acid or esters thereof, and dihaloanthracenes, preferably 1,5- or 9,10-dihaloanthracene,
dihalo-substituted triarylamines and their bisboronic acids or esters thereof and their alkyl- or alkoxy-substituted derivatives,
dihalo-substituted fluorenes and their bisboronic acids or esters thereof and their alkyl- or alkoxy-substituted derivatives,
dihalo-substituted carbazoles and their bisboronic acids or esters thereof and their alkyl- or alkoxy-substituted derivatives,
dihalo-substituted dibenzofuranes and their bisboronic acids or esters thereof and their alkyl- or alkoxy-substituted derivatives,
dihalo-substituted pyrenes and their bisboronic acids or esters thereof and their alkyl- or alkoxy-substituted derivatives,
dihalo-substituted phenanthrenes and their bisboronic acids or esters thereof and their alkyl- or alkoxy-substituted derivatives,
dihalo-substituted fluoranthenes and their bisboronic acids or esters thereof and their alkyl- or alkoxy-substituted derivatives.

Suitable alkyl or alkoxy substituents are C₅-C₁₂-alkyl or C₅-C₁₂-alkoxy side chains, with the abovementioned compounds preferably bearing, if appropriate, one or two alkyl or alkoxy substituents.

The further comonomer or comonomers is/are particularly preferably selected from the group consisting of phenylenebisboronic acids, phenylenebisboronic esters, dihalo-substituted benzenes, anthracenebisboronic acids, anthracenebisboronic esters, dihaloanthracenes, dihalofluoranthenes, fluorenebisboronic acids, fluorenebisboronic esters and the alkyl-substituted derivatives of the compounds mentioned.

In a further embodiment, the present invention provides the process of the invention in which polynaphthalenes which comprise repeating units of the formula Ia or Ib and have at least one crosslinkable radical R¹, R², R^{1′} or R^{2′} selected from among

CH═CH₂, —C≡CH, trans- or cis-CH═CH—C₆H₅, acryloyl, methacryloyl, ortho-methylstyryl, para-methylstyryl, —O—CH═CH₂, glycidyl, 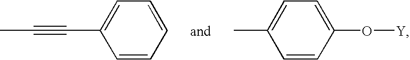
where Y is acryloyl, methacryloyl, ortho- or para-methylstyryl, —O—CH═CH₂, glycidyl or trans- or cis-CH═CH—C₆H₅,
are crosslinked.

The abovementioned radical or radicals R¹, R², R^{1′} and/or R^{2′} here serve(s) as crosslinker(s). For example, as such “end capping” can occur when a repeating unit of the formula Ia or Ib has one of the radicals specified above for R¹, R², R^{1′} or R^{2′} at the beginning of the polymer chain and a second repeating unit of the formula Ia or Ib has one of the radicals specified above for R¹, R², R^{1′ or R}^{2′} at the end of the polymer chain.

During processing, for example in spin coating of polymer firms made up of the polynaphthalenes of the invention, crosslinking of the polynaphthalenes according to the present invention serves to crosslink these films thermally or photochemically and thus make them insoluble in solvents. Crosslinking is generally effected after the polymerization during the processing of the polynaphthalene derivatives of the invention and can be effected thermally or photochemically.

Thermal crosslinking is preferably carried out by heating the polynaphthalene derivatives according to the invention which have at least one crosslinkable radical R¹, R², R^{1′} or R^{2′} as defined above in bulk or in a solvent at preferably from 80 to 14° C. under inert gas, generally nitrogen or noble gas. The polynaphthalene derivative according to the invention containing at least one crosslinkable radical R¹, R², R^{1′} or R^{2′} is particularly preferably applied in bulk or in a solvent as a film, preferably on one of the electrodes or a further layer of the OLED, and heated for generally from 45 minutes to 90 minutes under nitrogen or noble gas. The preferred temperature range has been indicated above. The procedure for carrying out thermal crosslinking is known to those skilled in the art.

When carrying out thermal crosslinking, particular preference is given to at least one radical R¹, R², R^{1′} or R^{2′} in the polynaphthalene of the invention independently being trans- or cis-CH═CH—C₆H₅, ortho-methylstyryl, para-methylstyryl or 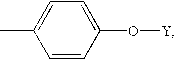
where Y is preferably trans- or cis-CH═CH—C₆H₅, ortho-methylstyryl or para-methylstyryl.

Photochemical crosslinking is preferably carried out by illuminating the polynaphthalene derivative according to the invention containing at least one crosslinkable radical R¹, R², R^{1′} or R^{2′} as mentioned above in bulk or in solution in the presence of a customary photoinitiator known to those skilled in the art from the photopolymerization of, for example, acrylic acid derivatives or methacrylic acid derivatives or unsaturated ethers with a radiation source, for example a UV lamp. The polynaphthalene derivative according to the invention having at least one crosslinkable radical R¹, R², R^{1′} or R^{2′} as mentioned above is preferably applied in bulk or in solution as a film, preferably to one of the electrodes or a further layer of the OLED, and illuminated in the presence of a customary photoinitiator with a radiation source, for example a UV lamp. The reaction conditions for photopolymerizations are known to those skilled in the art and are disclosed, for example, in EP-A 0 637 899.

When carrying out a photochemical polymerization or photopolymerization, preference is given to the radical or radicals R¹, R², R^{1′} or R^{2′} independently being acryloyl, methacryloyl, —O—CH═CH₂, glycidyl or 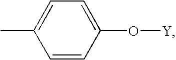
where Y is acryloyl, methacryloyl, —O—CH═CH₂ or glycidyl.

The present invention further provides polynaphthalenes which can be prepared by the process of the invention. Different polynaphthalenes can, depending on the embodiment of the invention, be obtained in this way. All the polynaphthalenes have electroluminescence properties so that the polynaphthalenes are suitable for use in OLEDs. Preferred embodiments of the process of the invention and of the radicals of the compounds used and thus of the radicals of the polynaphthalenes of the invention have been mentioned above. In a particularly preferred embodiment, the polynaphthalenes of the invention are 2,6-polynaphthalenes, i.e. the repeating naphthalene units are each linked via the 2 and 6 positions of the naphthalene skeleton.

The novel polynaphthalene derivatives obtained display an absorption maximum in the ultraviolet region of the electromagnetic spectrum and display an emission maximum in the blue region of the electromagnetic spectrum. The quantum yield of the polynaphthalene derivatives of the invention is generally from 40 to 80%, preferably from 50 to 60%. The quantum yield is determined by comparison with an internal standard (quinine sulfate dehydrate, 2 ppm in 0.5 M H₂SO₄) whose quantum yield is known from the literature.

The fact that it is possible to form films of the polynaphthalenes of the invention makes it possible to apply the polynaphthalenes from solution to electrodes in an OLED, for example by spin coating or dipping, which makes it possible to produce large-area displays simply and inexpensively.

The present invention therefore further provides films comprising or consisting of the polynaphthalenes of the invention or polynaphthalenes which are prepared by the process of the invention.

The present invention further provides organic light-emitting diodes (OLEDs) comprising at least one polynaphthalene according to the invention.

Organic light-emitting diodes (OLEDs) are basically made up of a plurality of layers:
1. anode
2. hole transport layer
3. light-emitting layer
4. electron transport layer
5. cathode

However, it is also possible for the OLED not to have all of the layers mentioned. For example, an OLED having the layers (1) (anode), (3) (light-emitting layer) and (5) (cathode), with the functions of the layers (2) (hole transport layer) and (4) (electron transport layer) being taken over by the adjoining layers, is likewise suitable. OLEDs comprising the layers (1), (2), (3) and (5) or the layers (1), (3), (4) and (5) are likewise suitable.

The polynaphthalenes of the invention are preferably used as emitter molecules in the light-emitting layer. The present invention therefore also provides a light-emitting layer comprising or consisting of at least one polynaphthalene according to the invention or at least one polynaphthalene which is prepared by the process of the invention.

The polynaphthalenes of the invention are generally present as such, i.e. without further additives, in the light-emitting layer. However, it is likewise possible for further compounds to be present in addition to the polynaphthalenes of the invention in the light-emitting layer. For example, a fluorescent dye can be present in order to alter the emission color of the polynaphthalene used as emitter substance. Furthermore, a diluent can be used. This diluent can be a polymer, for example poly(N-vinylcarbazole) or polysilane. If a diluent is used, the proportion of the polynaphthalenes used according to the invention in the light-emitting layer is generally less than 20% by weight, preferably from 3 to 10% by weight.

The individual abovementioned layers of the OLED can in turn be made up of two or more layers. For example, the hole transport layer can be made up of a layer into which holes are injected from the electrode and a layer which transports the holes away from the hole injection layer to the light-emitting layer. The electron transport layer can likewise consist of a plurality of layers, for example a layer into which electrons are injected by the electrode and a layer which receives electrons from the electron injection layer and transports them to the light-emitting layer. These layers are each selected according to factors such as energy level, heat resistance and charge carrier mobility and also energy difference between the layers mentioned and the organic layers or the metal electrodes. A person skilled in the art will be able to select the structure of the OLEDs in such a way that it is optimally matched to the polynaphthalenes used according to the invention as emitter substances.

To obtain particularly efficient OLEDs, the HOMO (highest occupied molecular orbital) of the hole transport layer should be matched to the work function of the anode and the LUMO (lowest unoccupied molecular orbital) of the electron transport layer should be matched to the work function of the cathode.

The present invention further provides an OLED comprising at least one light-emitting layer according to the invention. The further layers in the OLED can be made up of any material which is customarily used in such layers and is known to those skilled in the art.

The anode (1) is an electrode which provides positive charge carriers. It can, for example, be made up of materials comprising a metal, a mixture of various metals, a metal alloy, a metal oxide or a mixture of various metal oxides. As an alternative, the anode can be a conductive polymer. Suitable metals include the metals of groups IA, IVB, VB and VIB of the Periodic Table of the Elements and transition metals of group VIII. If the anode is to be transparent to light, use is generally made of mixed metal oxides of groups IIB, IIIA and IVA of the Periodic Table of the Elements (CAS version), for example indium-tin oxide (ITO). It is likewise possible for the anode (1) to comprise an organic material, for example polyaniline, as described, for example, in Nature, Vol. 357, pages 477 to 479 (Jun. 11, 1992). At least one of the anode or cathode should be at least partially transparent to enable the light produced to be emitted.

Suitable hole transport materials for layers (2) of the OLED of the invention are disclosed, for example, in Kirk-Othmer Encyclopedia of Chemical Technologie, 4th edition, vol. 18, pages 837 to 860, 1996. Both hole-transporting molecules and polymers can be used as hole transport material. Customarily used hole-transporting molecules are selected from the group consisting of 4,4′-bis[N-(1-naphthyl)-N-phenylamino]biphenyl (α-NPD), N,N′-diphenyl-N,N′-bis(3-methylphenyl)[1,1′-biphenyl]-4,4′-diamine (TPD), 1,1-bis[(di-4-tolylamino)phenyl]cyclohexane (TAPC), N,N′-bis(4-methylphenyl)-N,N′-bis(4-ethylphenyl)[1,1′-( 3,3′-dimethyl)biphenyl]-4,4′-diamine (ETPD), N,N,N′,N′-tetrakis-(3-methylphenyl)-2,5-phenylenediamine (PDA), α-phenyl-4-N,N-diphenylaminostyrene (TPS), p-(diethylamino)benzaldehyde diphenylhydrazone (DEH), triphenylamine (TPA), bis[4-(N,N-diethylamino)-2-methylphenyl)(4-methylphenyl)methane (MPMP). 1-phenyl-3-[p-(diethylamino)styryl]-5-[p-(diethylamino)phenyl]pyrazolin (PPR or DEASP), 1,2-trans-bis(9H-carbazol-9-yl]cyclobutane (DCZB), N,N,N′,N′-tetrakis(4-methylphenyl)-(1,1′-biphenyl)-4,4′-diamine (TTB) and porphyrin compounds and also phthalocyanines such as copper phthalocyanines. Customarily used hole-transporting polymers are selected from the group consisting of polyvinylcarbazoles and derivatives thereof, polysilanes and derivatives thereof, for example (phenylmethyl)polysilanes and polyanilines, polysiloxanes and derivatives having an aromatic amino group in the main or side chain, polythiophene and derivatives thereof, preferably PEDOT (poly(3,4-ethylenedioxythiophene), particularly preferably PEDOT doped with PSS (polystyrene-sulfonate), polypyrrole and derivatives thereof, poly(p-phenylene-vinylene) and derivatives thereof. Examples of suitable hole transport materials are mentioned, for example, in JP-A 63070257, JP-A 63175860, JP-A 2 135 359, JP-A 2 135 361, JP-A 2 209 988, JP-A 3 037 992 and JP-A 3 152 184. It is likewise possible to obtain hole-transporting polymers by doping polymers such as polystyrene, polyacrylate, poly(methacrylate), poly(methylmethacrylate), poly(vinylchloride), polysiloxane and polycarbonate with hole-transporting molecules. For this purpose, hole-transporting molecules are dispersed in the polymers mentioned, which serve as polymeric binders. Suitable hole-transporting molecules are the molecules mentioned above. Preferred hole transport materials are the hole-transporting polymers mentioned. Particular preference is given to polyvinylcarbazoles and derivatives thereof, polysiloxane derivatives having an aromatic amino group in their main or side chain and polythiophene-containing derivatives, in particular PEDOT-PSS. The preparation of the compounds mentioned as hole transport materials is known to those skilled in the art.

Suitable electron-transporting materials for layer (4) of the invention comprise metals chelated with oxinoid compounds, e.g. tris(8-quinolinolato)aluminum (Alq₃), compounds based on phenanthroline, e.g. 2,9-dimethyl,4,7-diphenyl-1,10-phenanthroline (DDPA=BCP) or 4,7-diphenyl-1,10-phenanthroline (DPA), and azole compounds such as 2-(4-biphenylyl)-5-(4-t-butylphenyl)-1,3,4-oxadiazole (PBD) and 3-(4-biphenylyl)-4-phenyl-5-(4-t-butylphenyl)-1,2,4-triazole (TAZ) anthraquinonedimethane and derivatives thereof, benzoquinone and derivatives thereof, naphthoquinone and derivatives thereof, fluorenon derivatives, diphenyldicyanoethylene and derivatives thereof, diphenoquinone derivates, polyquinoline and derivatives thereof, fluorenenon derivatives, diphenyldicyanoethylene and derivatives thereof, diphenoquinone derivatives, polyquinoline and derivatives thereof, polyquinoxaline and derivatives thereof and polyfluorene and derivatives thereof. Examples of suitable electron-transporting materials are disclosed, for example, in JP-A 63 070 257, JP-A 63 175 860, JP-A 2 135 359, JP-A 2 135 361, JP-A 2 209 988, JP-A 3 037 992 and JP-A 3 152 184. Preferred electron-transporting materials are azole compounds, benzoquinone and derivatives thereof, anthraquinone and derivatives thereof, polyfluorene and derivatives thereof. Particular preference is given to 2-(4-biphenyl)-5-(4-t-butylphenyl)-1,3,4-oxadiazole, benzoquinone, anthraquinone, Alq₃, BCP and polychinoline. The nonpolymeric electron-transporting materials can be mixed with a polymer as polymeric binder. Suitable polymeric binders are polymers which do not display a strong absorption of light in the visible region of the electromagnetic spectrum. Suitable polymers are the polymers mentioned above as polymeric binders in respect of the hole-transporting materials. The layer (4) can serve either to aid electron transport or as a buffer layer or barrier layer to avoid quenching of the exciton at the boundaries of the layers of the OLED. The layer (4) preferably improves the mobility of electrons and reduces quenching of the exciton.

Some of the materials mentioned above as hole-transporting materials and electron-transporting materials can fulfill a number of functions. For example, some of the electron-conducting materials are simultaneously hole-blocking materials if they have a low-laying HOMO.

The charge transport layers can also be electronically doped to improve the transport properties of the materials used so that, firstly, the layer thicknesses can be made more generous (avoidance of pinholes/short circuits) and, secondly, to minimize the operating voltage of the device. The hole transport materials can, for example, be doped with electron acceptors; for example, phthalocyanines or arylamines can be doped with TPD or TDTA can be doped with tetrafluorotetracyanoquinodimethane (F4-TCNQ). The electron transport materials can, for example, be doped with alkali metals, for example Alq₃ with lithium. Electronic doping is known to those skilled in the art and is disclosed, for example, in W. Gao, A. Kahn, J. Appl. Phys., vol. 94, No. 1, Jul. 1, 2003, p-dotierte organische Schichten) and A. G. Werner, F. Li, K. Harada, M. Pfeiffer, T. Fritz, K. Leo, Appl. Phys. Lett., vol. 82, No. 25, Jun. 23, 2003; Pfeiffer et al., Organic Electronics 2003, 4, 89 - 103).

The cathode (5) is an electrode which serves to introduce electrons or negative charge carriers. The cathode can be any metal or nonmetal which has a lower work function than the anode. Suitable materials for the cathode are selected from the group consisting of alkali metals of group IA, for example Li, Cs, alkali earth metals of group IIA, metals of group IIB of the Periodic Table of the Elements (CAS version) encompassing the rear earth metals and the lanthanides and actinides. Metals such as aluminum, indium, calcium, barium, samarium and magnesium and combinations thereof can also be used. Furthermore, lithium-containing organometallic compounds or LiF can be applied between the organic layer and the cathode to reduce the operating voltage.

The OLED of the present invention can further comprise additional layers which are known to those skilled in the art. For example, a further layer can be applied between the layer (2) and the light-emitting layer (3) in order to aid transport of the positive charge and/or to match the band gap of the layers to one another. As an alternative, this further layer can serve as protective layer. In an analogous way, additional layers can be present between the light-emitting layer (3) and the layer (4) to aid transport of the negative charge and/or match the band gap between the layers to one another. As an alternative, this layer can serve as protective layer.

In a further embodiment, the OLED of the invention contains, in addition to the layers (1) to (5), at least one of the following layers:
a hole injection layer between the anode (1) and the hole transport layer (2);
a blocking layer for electrons and/or excitons between the hole transport layer (2) and the light-emitting layer (3);
a blocking layer for holes and/or excitons between the light-emitting layer (3) and the electron transport layer (4);
an electron injection layer between the electron transport layer (4) and the cathode (5).

However, it is also possible for the OLED not to have all of the layers mentioned. For example, an OLED having the layers (1) (anode), (3) (light-emitting layer) and (5) (cathode), with the functions of the layers (2) (hole transport layer) and (4) (electron transport layer) being taken over by the adjoining layers, is likewise suitable. OLEDs comprising the layers (1), (2), (3) and (5) or the layers (1), (3), (4) and (5) are likewise suitable.

Particular preference is given to an OLED comprising the layers (1), (2), (3) and (5).

A person skilled in the art will know how to select suitable materials (for example on the basis of electrochemical studies). Suitable materials for the individual layers are known to those skilled in the art and are disclosed, for example, in WO 00/70655. Furthermore, each of the abovementioned layers of the OLED of the invention can be made up of one or more layers. It is also possible for some or all of the layers (1), (2), (3), (4) and (5) to be surface-treated in order to increase the efficiency of charge carrier transport. The choice of materials for each of the layers mentioned is preferably made so as to obtain an OLED having a high efficiency.

The OLED of the invention can be produced by methods known to those skilled in the art. In general, the OLED is produced by successive vapor deposition of the individual layers on a suitable substrate if the layers are made up of vaporizable molecules, i.e. molecules having a low molecular weight. Suitable substrates are preferably transparent substrates, for example glass or polymer films. The vapor deposition can be carried out using customary techniques such as thermal vaporization, chemical vapor deposition and others. In an alternative process, when the layers are made up of polymeric materials, the organic layers of the OLED can be applied from solutions or dispersions in suitable solvents, with coating techniques known to those skilled in the art, for example spin coating, printing or blade coating, being employed. The novel polynaphthalenes of the formula Ia or Ib are applied from solution, with, for example, ethers, chlorinated hydrocarbons, for example methylene chloride, and aromatic hydrocarbons, for example toluene, being suitable as organic solvents. The application itself can be carried out by means of conventional techniques, for example spin coating, dipping, by film-forming blade coating (screen printing technique), by application using an inkjet printer or by stamp printing, for example using PDMS (stamp printing using a silicone rubber stamp which has been photochemically structured).

In general, the various layers have the following thicknesses: anode (2) from 500 to 5 000 Å, preferably from 1 000 to 2 000 Å; hole transport layer (3) from 50 to 1 000 Å, preferably from 200 to 800 Å, light-emitting layer (4) from 10 to 2 000 Å, preferably from 30 to 1 500 Å, electron transport layer (5) from 50 to 1 000 Å, preferably from 100 to 800 Å, cathode (6) from 200 to 10 000 Å, preferably from 300 to 5 000 Å. The position of the recombination zone of holes and electrons in the OLED of the invention and thus the emission spectrum of the OLED can be influenced by the relative thickness of each layer. This means that the thickness of the electron transport layer should preferably be selected so that the electron-hole recombination zone is located in the light-emitting layer. The ratio of the thicknesses of the individual layers in the OLED is dependent on the materials used. The thicknesses of any additional layers used are known to those skilled in the art.

The use of the polynaphthalenes of the invention in the light-emitting layer of the OLEDs of the invention makes it possible to obtain OLEDs having a high efficiency. The efficiency of the OLEDs of the invention can also be improved by optimizing the other layers. For example, highly efficient cathodes such as Ca, Ba or LiF can be used. Shaped substrates and new hole transport materials which effect a reduction in the operating voltage or an increase in the efficiency can likewise be used in the OLEDs of the invention. Furthermore, additional layers can be present in the OLEDs to adjust the energy levels of the various layers and to aid electroluminescence.

The OLEDs of the invention can be used in all devices in which electroluminescence is useful. Suitable devices are preferably selected from among stationary and mobile VDUs. Stationary VDUs are, for example, VDUs of computers, televisions, VDUs in printers, kitchen appliances and advertising signs, lighting and information signs. Mobile VDUs are, for example, VDUs in mobile telephones, laptops, vehicles and destination displays on buses and trains.

The polynaphthalenes of the invention can also be used in OLEDs having an inverse structure. In these inverse OLEDs, the polynaphthalenes used according to the invention are once again preferably used in the light-emitting layer, particularly preferably as light-emitting layer without further additives. The structure of inverse OLEDs and the materials customarily used therein are known to those skilled in the art.

The novel polynapthalenes comprising repeating units of the formulae Ia and/or Ib are thus suitable as emitter substances, in particular as blue emitters, in organic light-emitting diodes. The present invention thus further provides for the use of the polynaphthalenes of the invention comprising repeating units of the formulae Ia and/or Ib or of polynaphthalenes which comprise repeating units of the formula Ia and/or Ib and have been prepared by the process of the invention as emitter substances in organic light-emitting diodes.

The following examples illustrate the invention.

### EXAMPLES

### Monomer Syntheses

### 2,6-dibromo-naphthalene-1,5-diol

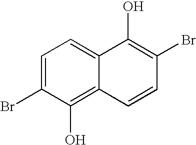

15 g of 1,5-dihydroxynaphthalene were dispersed in 350 ml of acetic acid and heated to 80° C. A spatula tip of iodine was added and 30 ml of bromine were added dropwise over a period of 90 minutes. The mixture is then stirred at 80° C. for another hour. The green solution is decantered off and the solid obtained is recrystallized twice from acetic acid. This gives 28 g of brownish crystals.

c.f. Eur. J. Org. Chem. 1999, 643.

### 6,6′-dibromo-2,2′-bisalkoxy-[1,1′]binaphthalenyl

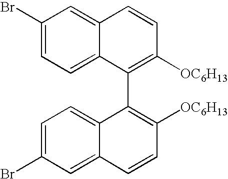

5.35 g of potassium carbonate, 0.5 g of sodium iodide and 10 g of 6,6′-dibromo-[1,1′]binaphthalenyl-2,2′-diol are dissolved in 20 ml of dry DMF and the solution is carefully degassed. After heating to 100° C., 9.3 g of bromohexane are added slowly and the mixture is heated at 100° C. for another 24 hours. The mixture is shaken with cyclohexane and, after recrystallization, 5 g of a white solid are obtained.

Further alkyl radicals can be introduced in a manner analogous to the hexyl radical.

### 2,6dibromo-1,5-bishexyloxynaphthalene

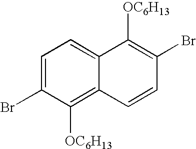

5.35 g of sodium ethoxide are dissolved in 50 ml of dry ethanol and the solution is carefully degassed. 10 g of 2,6-dibromonaphthalene-1,5-diol are then added and degassing is repeated. After heating to 95° C. for 35 minutes, 13 g of bromohexane are slowly added and the mixture is heated for another 2 hours at 90° C. The dark solid obtained is chromatographed on aluminum oxide (ethanol/dichloromethane). This gives 1.7 g of a yellow solid.

c.f. Eur. J. Org. Chem. 1999, 643.

### Oligomers

### [2,2′;6′,2″]ternaphthalenes

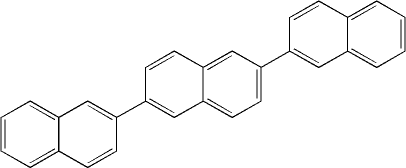

2 g of 2,6-dibromonaphthalene, 2.67 g of 2-naphthaleneboronic acid, 1 spatula tip of triethylbenzylammonium chloride and 0.8 g of tetrakis(triphenylphosphino)palladium(0) were heated in a mixture of 40 ml of tetrahydrofuran and 10 ml of 30% strength potassium carbonate solution at 80° C. under argon for 3 days. The reaction mixture is subsequently extracted a number of times with hot dichloromethane and purified by means of preparative thin layer chromatography (eluent: cyclohexane). This gives a yellowish solid.

Quantum yield (toluene)=77%, λ_{max,em} (toluene)=390 m, λ_{max,em} (film)=403 nm

### Polymer Syntheses

The polymer syntheses were carried out by methods known to those skilled in the art, Suzuki polymerizations using palladium are described, for example, in WO 00/22026 and WO 00/53656 and Yamamoto polymerizations using Nickel (0) are described in U.S. Pat. No. 5,708,130.

### Polymerization of 2,6-dibromo-1,5-bishexyloxynaphthalene

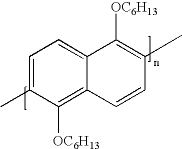

0.35 g of 2,6-dibromo-1,5-bishexyloxynaphthalene, 0.46 g of bis(1,5-cyclooctadiene)nickel (0), 0.26 g of 2,2′-bipyridine and 0.11 g of 1,5-cyclooctadiene were heated in a mixture of 10 ml of dimethylformamide and 10 ml of toluene at 80° C. under argon for 3 days. The reaction mixture is precipitated in an acetone/methanol/hydrochloric acid mixture, and subsequently a number of times in methanol. This gives a beige-brown solid.

Quantum yield (film)=54%, M_{w}=4200, λ_{max,em} (toluene)=385 nm, λ_{max,em} (film)=480 nm

### Polymerization of 2,6-dibromo-1,5-bishexyloxynaphthalene and 9,10-dibromoanthracene

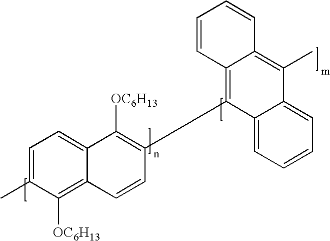

0.75 g of 2,6-dibromo-1,5-bishexyloxynaphthalene, 0.07 g of 9,10-dibromoanthracene, 0.98 g of bis(1,5-cyclooctadiene)nickel(0), 0.55 g 2,2′-bipyridine and 0.24 g of 1,5-cyclooctadiene were heated in a mixture of 15 ml of dimethylformamide and 15 ml of toluene at 80° C. under argon for 3 days. The reaction mixture is precipitated in an acetone/methanol/hydrochloric acid mixture, and subsequently a number of times in ethanol. This gives a beige-brown solid.

M_{w}=3000, λ_{max,em} (film)=445 nm

### Polymerization of 2,6-dibromo-1,5-bishexylnaphthalene and 1,3-dibromobenzene

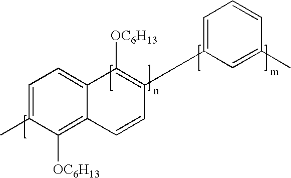

0.75 g of 2,6-dibromo-1,5-bishexyloxynaphthalene, 0.13 g of 1,3-dibromobenzene, 0.98 of bis(1,5-cyclooctadiene)nickel(0), 0.55 g of 2,2′-bipyridine and 0.24 g of 1,5-cyclooctadiene were heated in a mixture of 15 ml of dimethylformamide and 15 ml of toluene at 80° C. under argon for 3 days. The reaction mixture is precipitated in an acetone/methanol/hydrochloric acid mixture, and subsequently a number of times in methanol. This gives a beige-brown solid.

Quantum yield (film)=17%, M_{w}=3800, λ_{max,em} (film)=473 nm

### Polymerization of 2,6-dibromo-1,5-bishexyloxynaphthalene

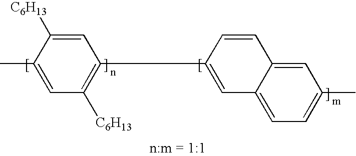

0.44 g of 2,6-dibromonaphthalene, 0.63 g of 1,4-dibromo-2,5-dihexylbenzene, 2 g of bis(1,5-cyclooctadiene)nickel(0), 1.1 g of 2,2′-bipyridine and 0.49 g of 1,5-cyclooctadiene were heated in a mixture of 14 ml of dimethylformamide and 4 ml of toluene at 80° C. under argon for 3 days. The reaction mixture is precipitated in an acetone/methanol/hydrochloric acid mixture, and subsequently a number of times in methanol. This gives a beige-brown solid.

Quantum yield (solution)=57%, M_{w}=4300, λ_{max,em} (THF)=397 nm

### Polymerization of 2,6-dibromo-1,5-bishexyloxynaphthalene

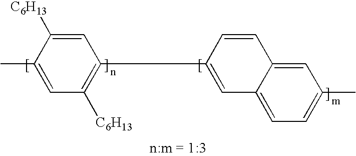

Quantum yield (solution)=55%, M_{w}=4000, λ_{max,em} (THF)=395 nm

### Polymerization of 2,6-dibromo-1,5-bishexyloxynaphthalene and 7,10-bis(4-bromo-phenyl)-8-nonyl-9-octylfluoranthene

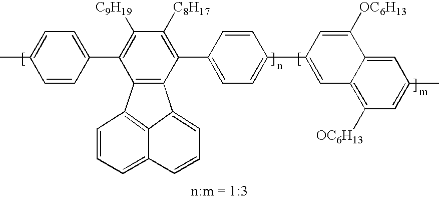

0.75 g of 2,6-dibromo-1,5-bishexyloxynaphthalene, 0.39 g of 7,10-bis(4-bromo-phenyl)-8-nonyl-9-octylfluoranthene, 1 g of bis(1,5-cyclooctadiene)nickel(0), 0.55 g of 2,2′-bipyridine and 0.24 g of 1,5-cyclooctadiene were heated in a mixture of 15 ml of dimethylformamide and 15 ml of toluene at 80° C. under argon for 3 days. The reaction mixture is precipitated in an acetone/methanol/hydrochloric acid mixture, and subsequently a number of times in methanol. This gives a brown solid.

Quantum yield (film)=62%, M_{w}=27000, λ_{max,em} (THF)=472 nm

### Polymerization of 2,6-dibromo-1,5-bishexyloxynaphthalene and 6,6′-dibromo-2,2′-bismethoxymethoxy[1,1′]binaphthalenyl

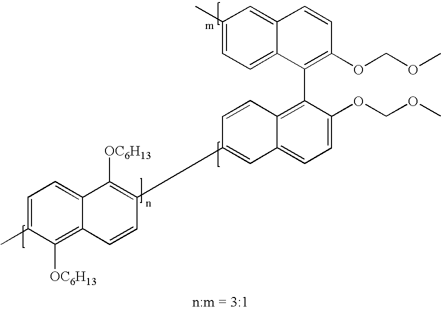

1.7 g of 2,6-dibromo-1,5-bishexyloxynaphthalene, 0.6 g of 6,6′-dibromo-2,2′-bismethoxymethoxy[1,1′]binaphthalenyl, 3 g of bis(1,5-cyclooctadiene)nickel(0), 1.7 g of 2,2′-bipyridine and 0.7 g of 1,5-cyclooctadiene were heated in a mixture of 12 ml of dimethylformamide and 9 ml of toluene at 80° C. under argon for 3 days. The reaction mixture is precipitated in an acetone/methanol/hydrochloric acid mixture, and subsequently a number of times in methanol. This gives an ochre solid.

Quantum yield (film)=28%, M_{w}=20600, λ_{max,em} (THF)=387 nm

1-16. (canceled)

17. A process for preparing polynaphthalenes comprising repeating units of the general formula Ia 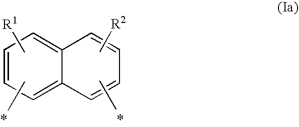
comprising polymerization of a monomeric naphthalene derivative of the formula IIa 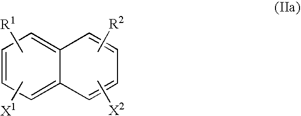
if appropriate together with at least one further comonomer selected from the group consisting of further naphthalene derivatives of the formula IIa which are different from the first naphthalene derivative of the formula IIa, aromatic, fused aromatic, heteroaromatic compounds, fluoranthene derivatives, benzene derivatives, anthrylene compounds, arylamino compounds, fluorene derivatives, carbazole derivatives, dibenzofuran derivatives, pyrene derivatives, phenanthrene derivatives, perylene derivatives, rubrene derivatives and thiophene compounds which each have two groups X³ and X⁴which are capable of polymerization with the groups X¹ and X² of the naphthalene derivative of the formula IIa
or for preparing polynaphtalenes comprising repeating units of the general formula Ib 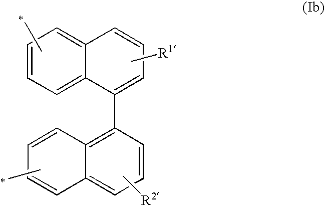
comprising polymerization of a monomeric naphthalene derivative of the formula IIb 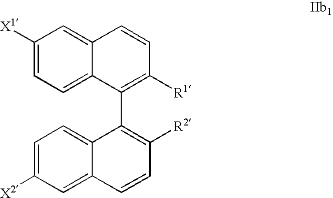
where the symbols have the following meanings:
R¹, R² are each independently of one another, H, an alkyl radical, an alkoxy radical, an aromatic radical, an aryloxy radical, a fused aromatic ring system, a heteroaromatic radical, an oligophenyl group;
R^{1′}, R^{2′} are each, independently of one another, H, an alkyl radical, an alkoxy radical, an aromatic radical, an aryloxy radical, a fused aromatic ring system, a heteroaromatic radical;
or
R¹ or R²
or
R^{1′} or R^{2′} are each, independently of one another, —CH═CH₂, —C≡CH, trans- or cis-CH═CH—C₆H₅, acryloyl, methacryloyl. ortho-methylstyryl, para-methylstyryl, —O—CH═CH₂, glycidyl, 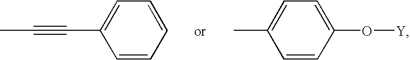
where Y is acryloyl, methacryloyl, ortho-methylstyryl, para-methylstyryl, —O—CH═CH₂, glycidyl or trans- or cis-CH═CH—C₆H₅;
X¹, X², X³,
X⁴, X¹, X² are groups capable of polymerization with one another.

18. The process according to claim 17, wherein R¹ and R² and R^{1′} and R^{2′} are selected from the group consisting of C₃-C₁₀-alkyl radicals and C₃-C₉-alkoxy radicals.

19. The process according to claim 17, wherein, in the monomeric naphthalene derivatives of the formula IIa, the radical R¹ is located in the ortho position relative to the radical X¹ and/or the radical R² is located in the ortho position relative to the radical X².

20. The process according to claim 17, wherein, in the monomeric naphthalene derivatives of the formula IIa, the group X¹ is located in the 2 position of the naphthalene skeleton and the group X² is located in the 6 position of the naphthalene skeleton.

21. The process according to claim 17, wherein the monomeric naphthalene derivatives of the formula IIb have the formula IIb₁:

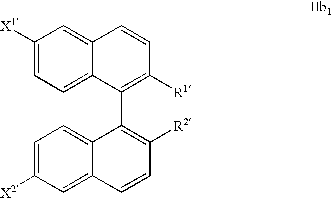

22. The process according to claim 17, wherein the polymerization is carried out in the presence of a nickel or palladium compound.

23. The process according to claim 22, wherein X¹, X², X^{1′}, X^{2′}, X³ and X⁴ have the following meanings:
X¹, X², and/or
X^{1′} and X^{2′},
X³ and X⁴ are each halogen selected from among F, Cl, Br and I, esterified sulfonate or a boron-containing radical of the formula —B(O—[C(R⁷)₂]ₙ—O or B(OR^{7′})₂
and
R⁷, R^{7′} are identical or different and each, independently of one another, H or C₁-C₂₀-alkyl;
n is an integer from 2 to 10;
with the proviso that
the radicals X¹ and X² and/or X^{1′} and X^{2′} and also X³ and X⁴ are selected so that the molar ratio of halogen and esterified sulfonate to boron-containing radicals is from 0.8:2.1 to 2.1:1, preferably from 0.9:1.1 to 1.1:0.9,
or
the radicals in the monomeric naphthalene derivative are each halogen and these are in the case of the monomeric naphthalene derivatives of formula IIa reacted, if appropriate, together with further comonomers in which the radicals X³ and X⁴ are likewise each halogen.

24. The process according to claim 22, wherein the further comonomer or comonomers is/are selected from the group consisting of phenylenebisboronic acids, phenylenebisboronic esters, dihalo-substituted benzenes, anthracenebisboronic acids, anthracenebisboronic esters, dihaloanthracenes, dihalo-substituted fluoranthenes, fluoranthenebisboronic acids, fluoranthenebisboronic esters and the alkyl-substituted derivatives of the compounds mentioned.

25. The process according to claim 17, wherein polynaphthalenes which comprise repeating units of the formula Ia or Ib and have at least one radical R¹, R², R^{1′} or R^{2′} selected from among
CH═CH₂, —C≡CH, trans- or cis-CH═CH—C₆H₅, acryloyl, methacryloyl, ortho-methylstyryl, para-methylstyryl, —O—CH═CH₂, glycidyl, 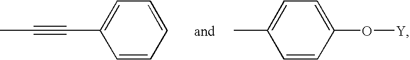
where Y is acryloyl, methacryloyl, ortho- or para-methylstyryl, —O—CH═CH₂, glycidyl or trans- or cis-CH═CH—C₆H₅,
are crosslinked.

26. A polynaphthalene comprising which can be prepared by a process according to claim 17.

27. A film comprising or consisting of at least one polynaphthalene according to claim 26.

28. An organic light-emitting diode comprising at least one polynaphthalene according to claim 26.

29. A light-emitting layer comprising or consisting of at least one polynaphthalene according to claim 26.

30. An organic light-emitting diode comprising a light-emitting layer according to claim 29.

31. A device selected from the group consisting of stationary VDUs, VDUs in printers, kitchen appliances and advertising signs, lighting, information signs and mobile VDUs in mobile telephones, laptops, vehicles and destination displays on buses and trains comprising an OLED according to claim 28.

32. Organic light-emitting diodes comprising polynaphthalenes according to claim 26 as emitter substances.

33. A device selected from the group consisting of stationary VDUs, VDUs in printers, kitchen appliances and advertising signs, lighting, information signs and mobile VDUs in mobile telephones, laptops, vehicles and destination displays on buses and trains comprising an OLED according to claim 30.
